(19) United States
(12) Patent Application Publication
(10) Pub. No.: US 2014/0347603 A1
(43) Pub. Date: Nov. 27, 2014

(54) LIGHT GUIDE PLATE, BACKLIGHT MODULE, AND LIQUID CRYSTAL DISPLAY DEVICE

(71) Applicant: HON HAI PRECISION INDUSTRY CO., LTD., New Taipei (TW)

(72) Inventor: CHEN-HAN LIN, New Taipei (TW)

(73) Assignee: HON HAI PRECISION INDUSTRY CO., LTD., New Taipei (TW)

(21) Appl. No.: 14/065,649

(22) Filed: Oct. 29, 2013

(30) Foreign Application Priority Data
May 23, 2013 (TW) 102118139

(51) Int. Cl. F21V 8/00

(52) U.S. Cl. CPC G02B 6/0031
USPC 349/64; 362/609; 362/607; 349/65

(57) ABSTRACT

A light guide plate includes an optically effective portion and an optical coupling portion adjoining the optically effective portion. The optically effective portion includes a first bottom surface, a light output surface opposite to the first bottom surface, and a side surface connected between the first bottom surface and the light output surface. The optical coupling portion includes a second bottom surface, a first light incident surface opposite to the side surface, a second light incident surface, a first connecting surface, and a second connecting surface. The second bottom surface is coplanar with the first bottom surface. The second light incident surface extends from the first light incident surface away from the side surface. The first connecting surface extends from the second light incident surface toward the side surface. The second connecting surface is connected between the first connecting surface and the light output surface.

### BACKGROUND

1. Technical Field

The present disclosure relates to a liquid crystal display device, a backlight module used in the liquid crystal display device, and a light guide plate used in the backlight module.

2. Description of Related Art

A side-type backlight module is used for illuminating a liquid crystal display panel in a liquid crystal display device. The backlight module includes a light source and a light guide plate optically coupled to the light source. However, with ongoing developments in liquid crystal display devices, the light guide plate becomes thinner and thinner, so part of the light emitted from the light source may not enter the light guide plate. Therefore, the light usage of the light source is reduced.

Therefore, it is desirable to provide a light guide plate, a backlight module having the light guide plate, and a liquid crystal display device having the backlight module, to overcome or at least alleviate the above mentioned problems.

### BRIEF DESCRIPTION OF THE DRAWINGS

FIG. 1 is a schematic side view of a liquid crystal display device, according to an exemplary embodiment.

FIG. 2 is a top view of the liquid crystal display device of FIG. 1.

### DETAILED DESCRIPTION

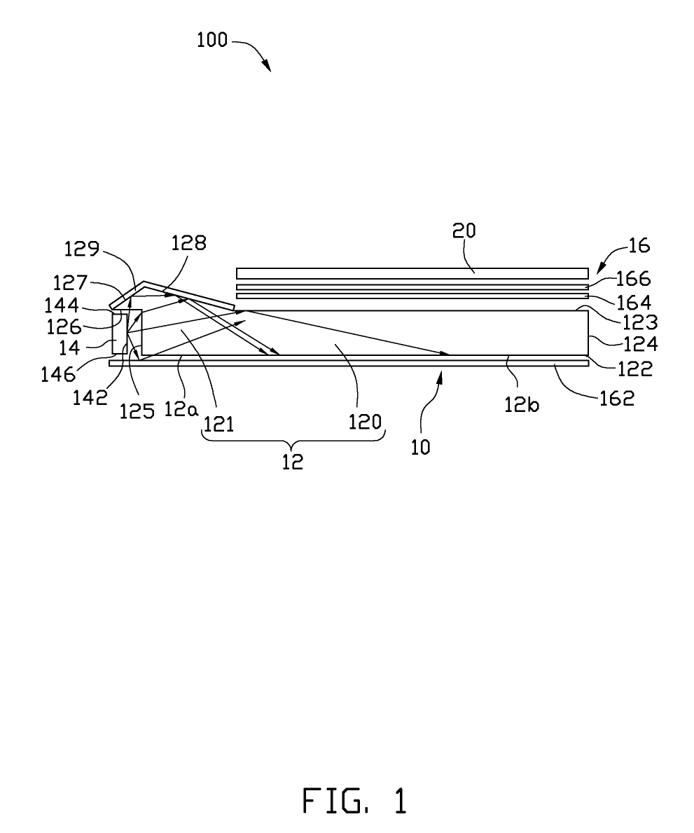

FIG. 1 shows a liquid crystal display device 100 according to an exemplary embodiment. The liquid crystal display device 100 includes a backlight module 10 and a liquid crystal display panel 20.

The backlight module 10 includes a light guide plate 12, a number of light sources 14, and an optical film unit 16.

The light guide plate 12 includes an optically effective portion 120 and an optical coupling portion 121 joined to the optically effective portion 120. The optically effective portion 120 is substantially a rectangular plate. The optically effective portion 120 and the optical coupling portion 121 are integrally formed by an injection molding process. The optically effective portion 120 includes a first bottom surface 12b. The optical coupling portion 121 includes a second bottom surface 12a. The first bottom surface 12b is coplanar with the second bottom surface 12a to form a common bottom surface 122.

The optically effective portion 120 further includes a light output surface 123 and a side surface 124. The light output surface 123 and the first bottom surface 12b are located at opposite sides of the optically effective portion 120, and the light output surface 123 is substantially parallel to the first bottom surface 12b. The side surface 124 is connected substantially perpendicularly between the light output surface 123 and the first bottom surface 12b.

The optical coupling portion 121 further includes a first light incident surface 125, a second light incident surface 126, a first connecting surface 127, a second connecting surface 128, and a reflection layer 129. The first light incident surface 125 and the side surface 124 are located at opposite sides of the light guide plate 12, and the first light incident surface 125 is substantially parallel to the side surface 124. The second light incident surface 126 perpendicularly extends from the first light incident surface 125 along a direction away from the side surface 124. The second light incident surface 126 and the common bottom surface 122 are located at opposite ends of the first light incident surface 125. The first connecting surface 127 extends from a side of the second light incident surface 126 opposite to the first light incident surface 125 toward the side surface 124. The first connecting surface 127 and the first light incident surface 125 are located at opposite sides of the second light incident surface 126. The second connecting surface 128 is connected between the first connecting surface 127 and the light output surface 123. In this embodiment, an included angle between the second connecting surface 128 and the light output surface 123 is an obtuse angle. The reflection layer 129 is coated on the first connecting surface 127 and the second connecting surface 128. The reflection layer 129 completely covers the first connecting surface 127 and the second connecting surface 128. In this embodiment, the reflection layer 129 is made of high reflective material, such as aluminum or nickel. In other embodiments, the reflection layer 129 is formed on a flexible printed board and is adhered to the first connecting surface 127 and the second connecting surface 128.

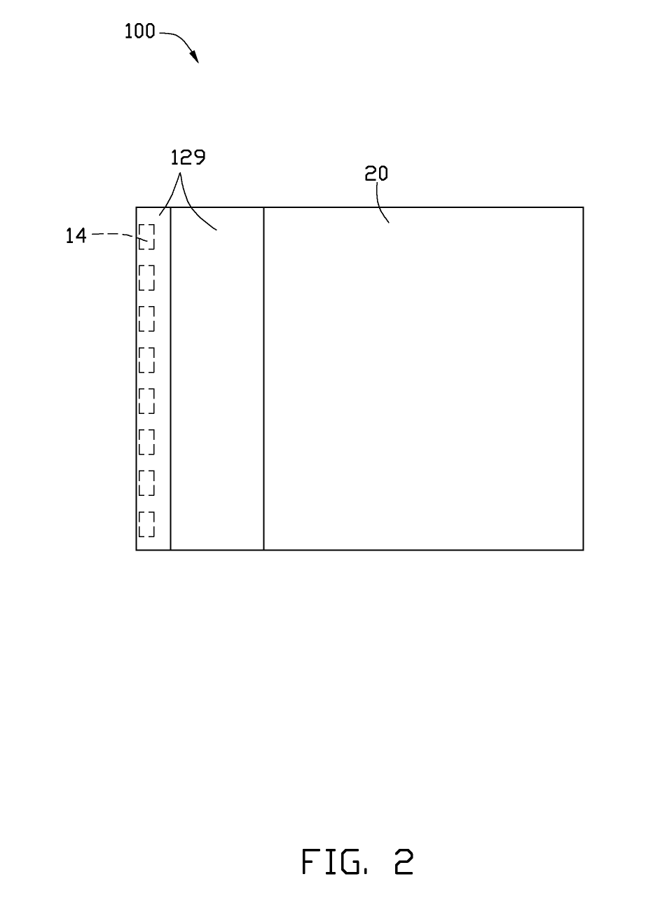

Referring to FIGS. 1-2, the light sources 14 are located adjacent to the first light incident surface 125. Each of the light sources 14 includes a light emitting surface 142, an upper end 144, and a lower end 146. Light emits from the light sources 14 through the light emitting surface 142. The upper end 144 and the lower end 146 are located at opposite ends of each of the light sources 14. The light emitting surfaces 142 of the light sources 14 face the first light incident surface 125. In this embodiment, the light sources 14 are arranged in a straight line, and the second light incident surface 126 completely covers the upper ends 144 of the light sources 14. Each of the light sources 14 is a light emitting diode (LED). In other embodiments, the backlight module 10 has a smaller size and only has one light source 14.

The optical film unit 16 includes a reflection plate 162, a diffusion plate 164, and a brightness enhancement film 166. The reflection plate 162 is located under the light guide plate 12 and faces the common bottom surface 122 and the light sources 14. The reflection plate 162 completely covers the lower ends 146 of the light sources 14. The diffusion plate 164 is located above the light output surface 123, and the brightness enhancement film 166 is located above the diffusion plate 164. Both the diffusion plate 164 and the brightness enhancement film 166 are made of resin. The diffusion plate 164 has diffusion particles therein. The liquid crystal display panel 20 is located above the brightness enhancement film 166.

In use, light emitted from the light sources 40 enters the optical coupling portion 121 through the first light incident surface 125 and the second light incident surface 126, and is guided into the optically effective portion 120 by the optical coupling portion 121. Light that passes through the common bottom surface 122 is reflected by the reflection plate 162 back into the optically effective portion 120. The light emits from the optically effective portion 120 through the light output surface 123. Light emitted from the optically effective portion 120 is transmitted through the diffusion plate 164 and the brightness enhancement film 166, and finally illuminates the liquid crystal display panel 20. In other embodiments, the reflection layer 129 may be omitted if the first connecting surface 127 and the second connecting surface 128 can completely reflect light into the optically effective portion 120.

More light emitted from the light sources 14 is concentrated into the light guide plate 12 because the light emitting surfaces 142 face the first light incident surface 125, and the second light incident surface 126 completely covers the upper ends 144 of the light sources 14. Therefore, the light usage ratio of the light sources 40 is increased. Furthermore, as the reflection layer 129 is formed on the first connecting surface 127 and the second connecting surface 128, leakage of light from the first connecting surface 127 and the second connecting surface 128 is prevented, and the greater concentration of light into the light guide plate 12 results in enhancement of the light usage ratio of the light sources 40. Moreover, light emitted from the lower ends 146 of the light sources 14 is reflected by the reflection plate 162 because the reflection plate 162 completely covers the lower ends 146. Therefore, the light usage ratio of the light sources 40 is further increased.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A light guide plate comprising:
a rectangular plated optically effective portion comprising a first bottom surface, a light output surface opposite to the first bottom surface, and a side surface perpendicularly interconnected between the first bottom surface and the light output surface; and
an optical coupling portion adjoining to the optically effective portion, the optical coupling portion comprising a second bottom surface, a first light incident surface, a second light incident surface, a first connecting surface, and a second connecting surface, the second bottom surface being coplanar with the first bottom surface, the first light incident surface being opposite to and parallel with the side surface, the second light incident surface perpendicularly extending from the first light incident surface along a direction away the side surface, the second light incident surface and the second bottom surface located at opposite ends of the first light incident surface, the first connecting surface extending from the second light incident surface along a direction toward the side surface, the first connecting surface and the first incident surface located at opposite sides of the second light incident surface, and the second connecting surface interconnected between the first connecting surface and the light output surface.

2. The light guide plate of claim 1, wherein the light guide plate is made of resin.

3. The light guide plate of claim 1, wherein the optically effective portion and the optical coupling portion are formed integrally by an injection molding process.

4. The light guide plate of claim 3, further comprising a reflection layer formed on the first connecting surface and the second connecting surface, wherein the reflection layer completely covers the first connecting surface and the second connecting surface.

5. A backlight module comprising:
a light guide plate comprising:
a rectangular plated optically effective portion comprising a first bottom surface, a light output surface opposite to the first bottom surface, and a side surface perpendicularly interconnected between the first bottom surface and the light output surface; and
an optical coupling portion adjoining the optically effective portion, the optical coupling portion comprising a second bottom surface, a first light incident surface, a second light incident surface, a first connecting surface, and a second connecting surface, the second bottom surface being coplanar with the first bottom surface to form a common bottom surface, the first light incident surface being opposite to and parallel with the side surface, the second light incident surface perpendicularly extending from the first light incident surface along a direction away the side surface, the second light incident surface and the second bottom surface located at opposite ends of the first light incident surface, the first connecting surface extending from the second light incident surface along a direction toward the side surface, the first connecting surface and the first incident surface located at opposite sides of the second light incident surface, and the second connecting surface interconnected between the first connecting surface and the light output surface; and
at least one light source, each light source comprising a light emitting surface and an upper end, the light emitting surface facing the first light incident surface, the second light incident surface completely covering the upper end.

6. The backlight module of claim 5, wherein the light source further comprises a lower end opposite to the upper end, the backlight module further comprises a reflection plate under the common bottom surface, and the reflection plate faces the common bottom surface and the lower end.

7. The backlight module of claim 6, further comprising a diffusion plate and a brightness enhancement film, the diffusion plate is positioned above the light output surface, and the brightness enhancement film is positioned above the diffusion plate.

8. The backlight module of claim 5, wherein the light guide plate is made of resin.

9. The backlight module of claim 7, wherein the optically effective portion and the optical coupling portion are formed integrally by an injection molding process.

10. The backlight module of claim 9, further comprising a reflection layer formed on the first connecting surface and the second connecting surface, wherein the reflection layer completely covers the first connecting surface and the second connecting surface.

11. A liquid crystal display panel comprising:
a backlight module comprising:
a light guide plate comprising:
a rectangular plated optically effective portion comprising a first bottom surface, a light output surface opposite to the first bottom surface, and a side surface perpendicularly interconnected between the first bottom surface and the light output surface; and
an optical coupling portion adjoining to the optically effective portion, the optical coupling portion comprising a second bottom surface, a first light incident surface, a second light incident surface, a first connecting surface, and a second connecting surface, the second bottom surface being coplanar with the first bottom surface to form a common bottom surface, the first light incident surface being opposite to and parallel with the side surface, the second light incident surface perpendicularly extending from the first light incident surface along a direction away the side surface, the second light incident surface and the second bottom surface located at opposite ends of the first light incident surface, the first connecting surface extending from the second light incident surface along a direction toward the side surface, the first connecting surface and the first incident surface located at opposite sides of the second light incident surface, and the second connecting surface interconnected between the first connecting surface and the light output surface; and
at least one light source, each light source comprising a light emitting surface and an upper end, the light emitting surface facing the first light incident surface, the second light incident surface completely covering the upper end; and
a liquid crystal display panel positioned above the light output surface.

12. The liquid crystal display panel of claim 11, wherein the light source further comprises a lower end opposite to the upper end, the backlight module further comprises a reflection plate under the common bottom surface, and the reflection plate faces the common bottom surface and the lower end.

13. The liquid crystal display panel of claim 12, further comprising a diffusion plate and a brightness enhancement film, the diffusion plate is positioned above the light output surface, the brightness enhancement film is positioned above the diffusion plate, and the diffusion plate and the brightness enhancement film are sandwiched between the light output surface and the liquid crystal display panel.

14. The liquid crystal display panel of claim 11, wherein the light guide plate is made of resin.

15. The liquid crystal display panel of claim 13, wherein the optically effective portion and the optical coupling portion are formed integrally by an injection molding process.

16. The liquid crystal display panel of claim 15, further comprising a reflection layer formed on the first connecting surface and the second connecting surface, wherein the reflection layer completely covers the first connecting surface and the second connecting surface.
